(19) United States
(12) Patent Application Publication
(10) Pub. No.: US 2025/0052205 A1
(43) Pub. Date: Feb. 13, 2025

(54) ENGINE THROTTLE DEVICE

(71) Applicant: MIKUNI CORPORATION, Tokyo (JP)

(72) Inventor: Atsushi OSANAI, Odawara-shi (JP)

(73) Assignee: MIKUNI CORPORATION, Tokyo (JP)

(21) Appl. No.: 18/785,485

(22) Filed: Jul. 26, 2024

(30) Foreign Application Priority Data
Aug. 7, 2023 (JP) 2023-128564

(51) Int. Cl. F02D 9/10

(52) U.S. Cl. CPC F02D 9/1065; F02D 9/106

(57) ABSTRACT

An engine throttle device 1 includes: a throttle shaft 4 supporting a throttle valve 7 inside a throttle bore of a throttle body 2 such that the throttle valve 7 is able to be opened and closed; and a gear case 18 fixed to a side portion of the throttle body 2 and accommodating gear trains, causes one end of the throttle shaft 4 to project into the gear case 18 via shaft holes 20 and 21, and drives the throttle shaft 4 via the gear trains 22, 26, and 29. The throttle device 1 further includes: an annular fitting portion 42 formed to be adjacent to the shaft hole 21; a bearing 6 having an outer ring 6b fitted to the annular fitting portion 42 and an inner ring 6a fitted to the throttle shaft 4, and rotatably supporting the throttle shaft 4; a positioning ring 45 press-fitted into the annular fitting portion 42 and abutting the outer ring 6b to restrict displacement of the outer ring 6b along an axis C of the throttle shaft 4; and a fixing nut 39 screwed onto one end of the throttle shaft 4 inside the gear case 18 and abutting the inner ring 6a on one end side to restrict displacement.

### BACKGROUND OF THE INVENTION

### Field of the Invention

The present invention relates to an engine throttle device.

### Description of the Related Art

In this type of throttle device, a throttle shaft is disposed to penetrate through a throttle bore of a throttle body with both end portions supported by bearings, and a throttle valve is opened and closed inside the throttle bore with rotation of the throttle shaft. Once the throttle shaft is displaced in a direction along an axis, that is, a thrust direction, both side portions of the throttle valve come into slide contact with an inner circumferential surface of the throttle bore, and a problem such as hinderance of smooth opening/closing operations may occur. Thus, a shaft support structure of positioning a throttle shaft in an axial direction has been proposed as described in Patent Literature 1, for example.

In a throttle device in Patent Literature 1, an outer ring of each of bearings supporting both end portions of the throttle shaft is pressure-fitted into each of annular fitting portions formed in a throttle body, and an inner ring of one of the bearings is sandwiched with a fixing nut between the fixing nut and a stepped surface of the throttle shaft. Also, an inner ring of the other bearing is biased in one direction with a compression spring via a receiving member with displacement of the throttle shaft in the axial direction allowed. In this manner, backlash between the inner and outer rings of the bearings and balls is reduced, and a throttle valve is positioned in the axial direction along with the throttle shaft.

### CITATION LIST

### Patent Literature

[Patent Literature 1] Japanese Patent Laid-Open No. 2009-293581

The throttle device in Patent Literature 1 described above has a problem that an external dimension of the throttle device increases in the axial direction of the throttle shaft by the amount corresponding to the entire length of the compression spring since it is necessary to provide the compression spring biasing the inner ring of the other bearing on the throttle shaft. Although a shaft support structure for a throttle shaft obtained by eliminating the compression spring may thus be employed, the positioning effect in the axial direction achieved by the compression spring cannot be obtained.

Therefore, once the throttle shaft is about to be displaced along the axis in response to some external force, the inner ring of the one bearing positioned with the fixing nut starts to be displaced integrally with the throttle shaft in the same direction, for example, and the force acts on the outer ring via the ball. In a case where the outer ring is fixedly positioned in the axial direction, an effect of restricting the displacement of the throttle shaft is obtained through the ball and the inner ring. However, merely the press-fitting in the annular fitting portion may allow the outer ring to move in the axial direction, it is not possible to restrict the displacement of the throttle shaft in that case, functions as a normal bearing may be damaged, and a measure has thus been required in the related art.

The present invention has been made in order to solve such a problem, and an object thereof is to provide an engine throttle device capable of reducing an external dimension of a throttle shaft in an axial direction and realizing smooth opening and closing of a throttle valve with the throttle shaft positioned in the axial direction.

### SUMMARY OF THE INVENTION

In order to achieve the above object, an engine throttle device according to the present invention is an engine throttle device in which a throttle valve is supported inside a throttle bore of a throttle body by a throttle shaft such that the throttle valve is able to be opened and closed, a gear case accommodating gear trains is fixed to a side portion of the throttle body, and one end of the throttle shaft is caused to project into the gear case via a shaft hole and is driven via the gear trains, the engine throttle device including: an annular fitting portion formed to be adjacent to the shaft hole; a bearing having an outer ring fitted to the annular fitting portion and an inner ring fitted to the throttle shaft, and rotatably supporting the throttle shaft; a positioning ring pressure-fitted into the annular fitting portion and abutting the outer ring to restrict displacement of the outer ring along an axis of the throttle shaft; and a fixing nut screwed onto the one end of the throttle shaft inside the gear case and abutting the inner ring on one end side to restrict displacement of the inner ring and the one end side.

In another aspect, the shaft hole may be formed in the gear case, and a case-side annular fitting portion as the annular fitting portion may be formed on the other end side of the shaft hole, and the positioning ring may abut the outer ring from the other end side inside the case-side annular fitting portion to restrict displacement of the outer ring to the other end side.

In another aspect, a movement restricting surface facing the other end side may be formed between the shaft hole and the case-side annular fitting portion in the gear case, and the positioning ring may position the outer ring in an axial direction of the throttle shaft with the outer ring sandwiched between the positioning ring and the movement restricting surface.

In another aspect, a body-side annular fitting portion that is adjacent to the other end side of the case-side annular fitting portion may be formed in the throttle body, and the positioning ring may be press-fitted into the case-side annular fitting portion and may be inserted into the body-side annular fitting portion.

In another aspect, a stepped surface facing the one end side may be formed in the throttle shaft, and the fixing nut may position an inner ring of the bearing in an axial direction of the throttle shaft with the inner ring sandwiched between the fixing nut and the stepped surface.

In another aspect, a collar with a cylindrical shape fitted to the throttle shaft and abutting the inner ring on one end side may be further included, and the fixing nut may sandwich the inner ring of the bearing between the fixing nut and the stepped surface via the collar.

In another aspect, an inner circumferential surface of the shaft hole may form a gap between the inner circumferential surface and an outer circumferential surface of the throttle shaft, and the collar may abut the inner ring as being arranged in the gap.

In another aspect, the shaft hole may be formed in the throttle body, and a body-side annular fitting portion as the annular fitting portion may be formed on the one end side of the shaft hole, and the positioning ring may abut the outer ring on the one end side inside the body-side annular fitting portion to restrict displacement of the outer ring to the one end side.

According to the engine throttle device of the present invention, it is possible to reduce the external dimension of the throttle shaft in the axial direction and to realize smooth opening and closing of the throttle valve with the throttle shaft positioned in the axial direction.

### BRIEF DESCRIPTION OF THE DRAWINGS

FIG. 1 is a perspective view illustrating an engine throttle device according to an embodiment;

FIG. 2 is a front view illustrating the throttle device;

FIG. 3 is a plan view illustrating the throttle device;

FIG. 4 is a right side view illustrating the throttle device;

FIG. 5 is a right side view illustrating gear trains inside a gear case;

FIG. 6 is a sectional view along the line VI-VI in FIG. 5;

FIG. 7 is an exploded perspective view illustrating a shaft support part of a right end portion of a throttle shaft;

FIG. 8 is an enlarged sectional view of the portion A in FIG. 6 illustrating the shaft support part of the right end portion of the throttle shaft; and

FIG. 9 is a sectional view illustrating another example and corresponding to FIG. 8 in which a positional relationship between a bearing and a positioning ring is reversed.

### DETAILED DESCRIPTION OF THE INVENTION

Hereinafter, an embodiment of an engine throttle device that implements the present invention will be described.

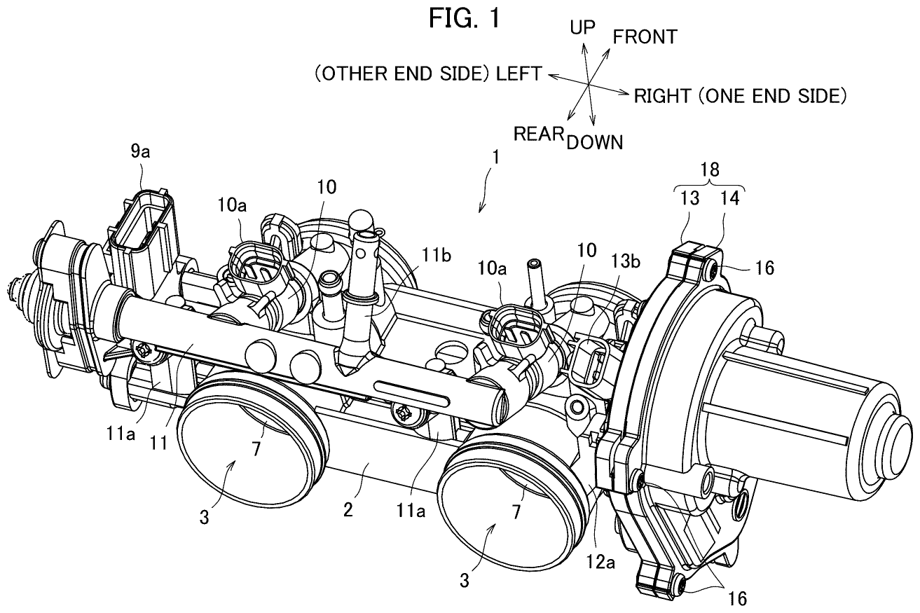

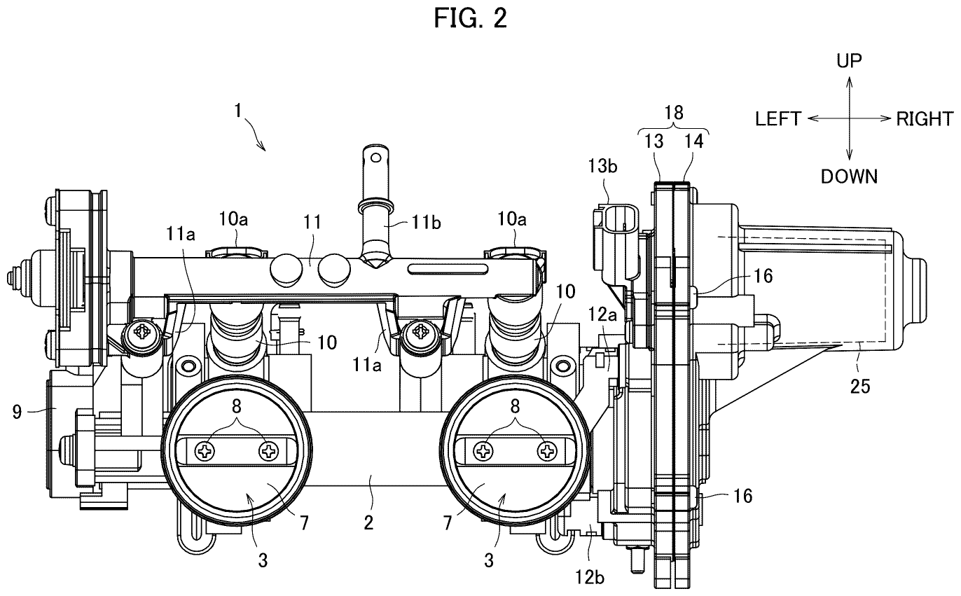

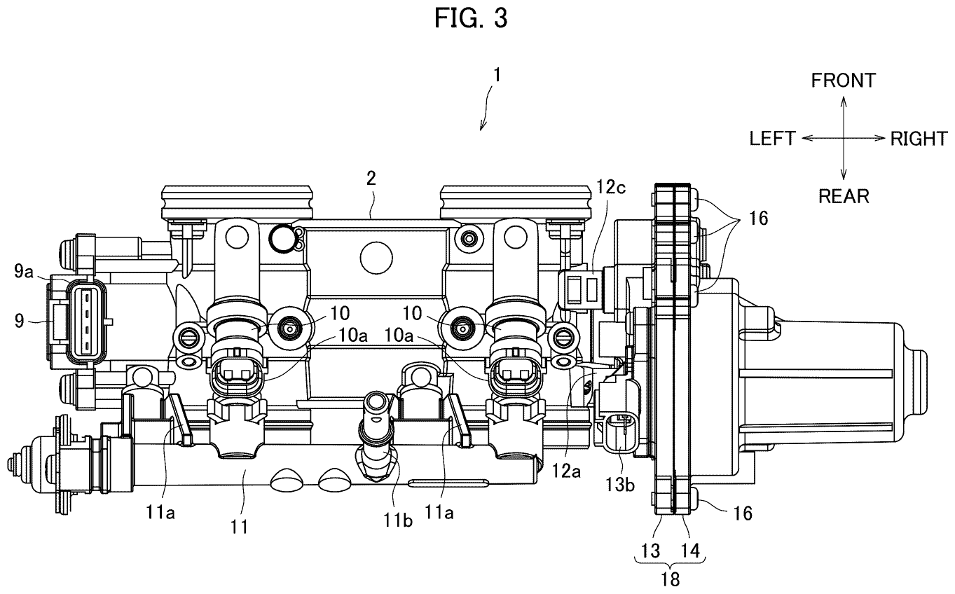

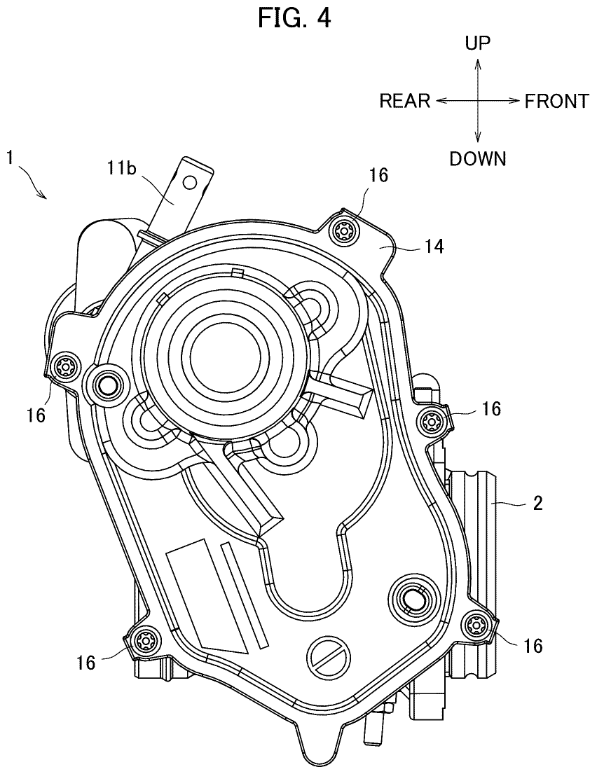

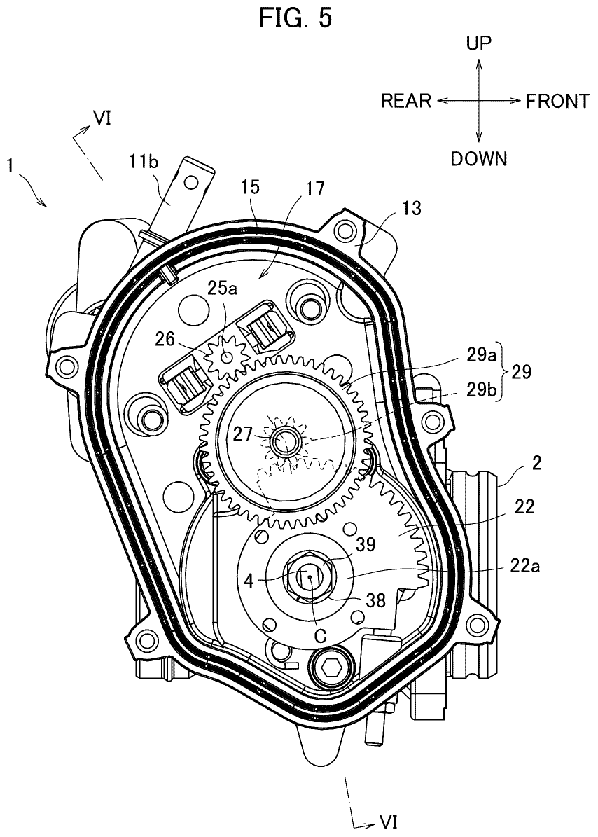

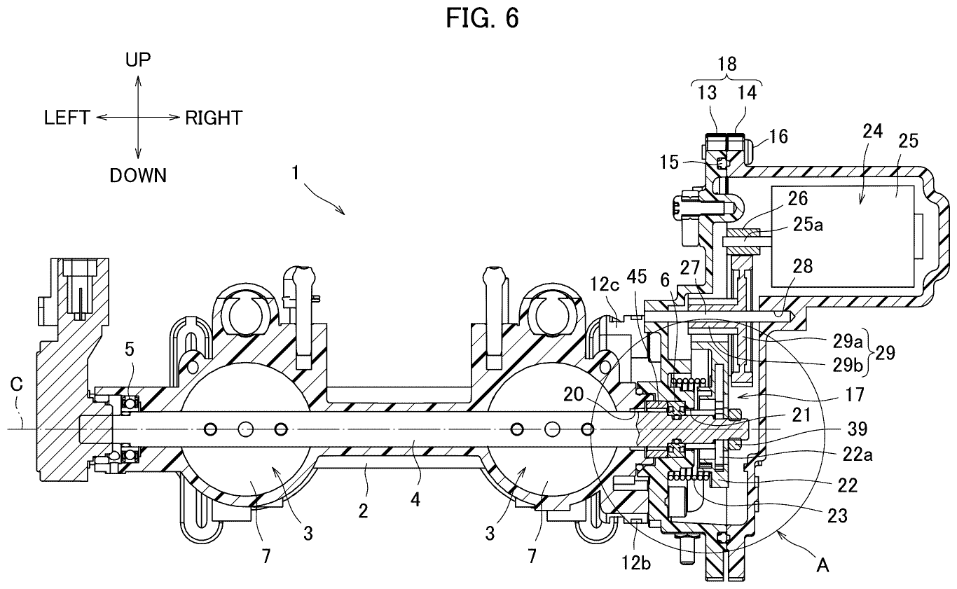

FIG. 1 is a perspective view illustrating the engine throttle device according to the embodiment, FIG. 2 is a front view illustrating the throttle device, FIG. 3 is a plan view illustrating the throttle device, FIG. 4 is a right side view illustrating the throttle device, FIG. 5 is a right side view illustrating gear trains inside a gear case, and FIG. 6 is a sectional view along the line VI-VI in FIG. 5.

A throttle device 1 in the present embodiment is applied to a two-cylinder engine mounted in a motorcycle. An engine is located on an obliquely upper right side in FIG. 1 in a state where the throttle device 1 is assembled with an engine mounted in a vehicle, and a driver rides the vehicle in a posture in which the driver faces the same direction. Thus, front-rear, left-right, and up-down directions will be expressed relative to the driver as a subject in the following description. In the embodiment, the right side corresponds to one end side in the present invention, and the left side corresponds to the other end side in the present invention.

As illustrated in FIGS. 1 to 3, a pair of left and right throttle bores 3 are provided in the front-rear direction to penetrate through a throttle body 2 of the throttle device 1. For example, the throttle body 2 is produced by injection-molding a synthetic resin material. Although not illustrated, a front end of each throttle bore 3 is connected to an intake manifold of the engine, and a rear end is connected to an air cleaner in a state where the throttle device 1 is mounted in the vehicle.

As illustrated in FIG. 6, one throttle shaft 4 is disposed in the throttle body 2 to penetrate through each throttle bore 3 in the left-right direction, a left end of the throttle shaft 4 is rotatably supported by a bearing 5, and a right end is rotatably supported by a bearing 6. A deep groove ball bearing, for example, is applied as each of the bearings 5 and 6. A throttle valve 7 is fixed to the throttle shaft 4 with a screw 8 in each throttle bore 3, and each throttle valve 7 is opened and closed in accordance with rotation of the throttle shaft 4. A rotation angle of the throttle shaft 4 is detected as throttle opening by a throttle sensor 9 coupled to the left end of the throttle shaft 4.

As illustrated in FIGS. 1 to 3, an injector 10 is attached to the throttle body 2 such that the injector 10 corresponds to each throttle bore 3, and a distal end of each injector 10 projects into the throttle bore 3 although not illustrated. A proximal end of each injector 10 is coupled to a common delivery pipe 11, and the delivery pipe 11 is supported on the throttle body 2 via a pair of left and right bracket portions 11a. Although not illustrated, a fuel hose extending from a fuel pump on a vehicle body side is connected to a nipple portion 11b provided in the delivery pipe 11, and couplers of harnesses extending from a controller for engine control on the vehicle body side are connected to a connector 9a provided in the throttle sensor 9 and a connector 10a provided in each injector 10, in a vehicle mounted state.

Fuel supplied through the fuel hose is distributed by the delivery pipe 11 and is supplied to each injector 10. Also, a detection signal related to the throttle opening detected by the throttle sensor 9 is input to the controller via the harness. The controller controls various devices attached to the engine on the basis of various kinds of information including the detection signal, and as a part of the control, the controller outputs a drive signal to each injector 10 via the harness to drive each injector 10. The fuel is injected into the throttle bore 3 in response to opening and closing of each injector 10 and is mixed with intake air, and the fuel is supplied to the inside of each cylinder of the engine as the mixture air and is used for combustion.

As illustrated in FIGS. 2, 5, and 6, three bracket portions 12a, 12b, and 12c are integrally formed on the right side of the throttle body 2, and a left case member 13 is fastened with a bolt, which is not illustrated, via each of the bracket portions 12a, 12b, and 12c. A right case member 14 is fastened to the left case member 13 with a screw 16 from the right side in a state where a waterproof packing 15 is sandwiched between the case members 13 and 14, and these case members 13 and 14 constitute a gear case 18 including a gear accommodating chamber 17 therein. For example, the left and right case members 13 and 14 are produced by injection-molding a synthetic resin material.

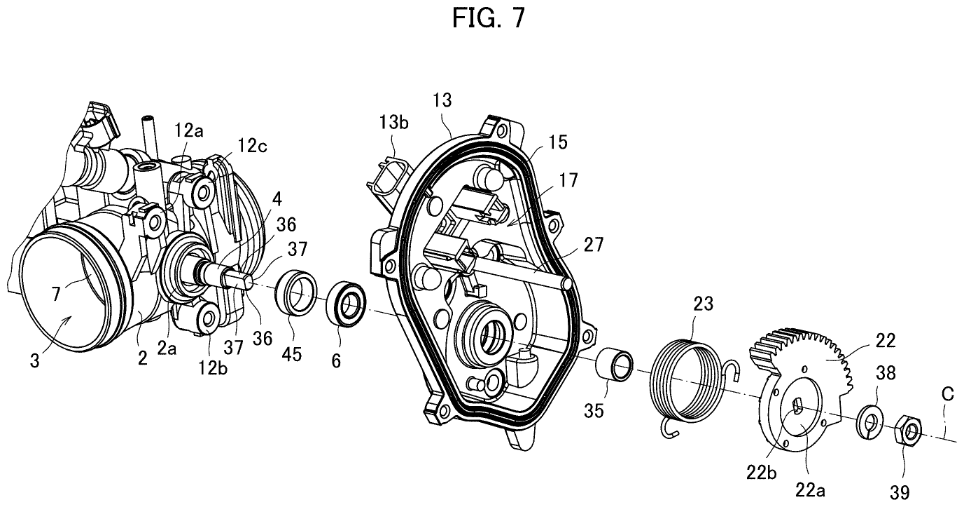

FIG. 7 is an exploded perspective view illustrating a shaft support part of the right end portion of the throttle shaft 4, and the section of the throttle shaft 4 corresponding to the side further rightward than the throttle valve 7 on the right side will be referred to as a right end portion in the following description.

As illustrated in FIGS. 5 to 7, the right end portion of the throttle shaft 4 is inserted into a shaft hole 20 formed in the throttle body 2 and a shaft hole 21 formed in the left case member 13, and the right end thereof projects into the gear accommodating chamber 17 with a sector-type driven gear 22 fixed thereto. The driven gear 22 is produced through injection molding using a flat plate-shaped core metal 22a as an insert material. A return spring 23 is wound around the throttle shaft 4, one end thereof is caught by the left case member 13, the other end is caught by the driven gear 22, and the throttle valve 7 is thereby biased in a closing direction along with the driven gear 22 and the throttle shaft 4. Since the shaft support structure at the right end portion of the throttle shaft 4 relates to a gist of the present invention, details will be described later.

An upper portion of the right case member 14 has a cylindrical shape and expands rightward, and a motor accommodating chamber 24 is formed therein and communicates with the gear accommodating chamber 17. A motor 25 is accommodated in the motor accommodating chamber 24, an output shaft 25a thereof projects into the gear accommodating chamber 17, and a driving gear 26 is fixed to the output shaft 25a. A gear shaft 27 is disposed at an intermediate position between the driving gear 26 and the driven gear 22, a proximal end thereof is buried in the left case member 13, and a distal end thereof is inserted into a shaft hole 28 formed in the right case member 14. An intermediate gear 29 including a large diameter portion 29a and a small diameter portion 29b is rotatably supported by the gear shaft 27, the large diameter portion 29a is engaged with the driving gear 26, and the small diameter portion 29b is engaged with the driven gear 22. The driven gear 22, the driving gear 26, and the intermediate gear 29 correspond to the gear trains in the present invention.

Once the motor 25 rotates either forward or backward, the rotation is decelerated via the driving gear 26, the large diameter portion 29a and the small diameter portion 29b of the intermediate gear 29, and the driven gear 22 and is transmitted to the throttle shaft 4, and the throttle shaft 4 rotates to open and close the throttle valve 7 while receiving a biasing force of the return spring 23. Although not illustrated, a coupler of a harness extending form the controller on the vehicle body side is connected to a connector 13b provided in the left case member 13 in the vehicle mounted state. The controller outputs a drive signal to the motor 25 via the harness to drive the motor 25, and opens and closes the throttle valve 7 in response to a driver's accelerator operation.

Next, the shaft support structure at the right end portion of the throttle shaft 4 will be described in detail.

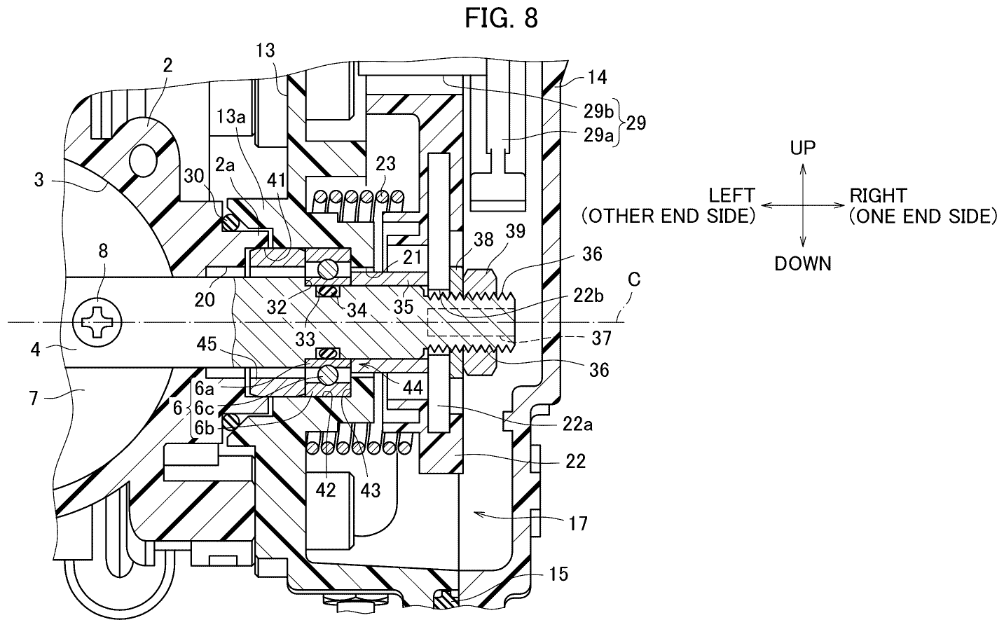

FIG. 8 is an enlarged sectional view of the portion A in FIG. 6 illustrating a shaft support part at the right end portion of the throttle shaft 4.

As described above, the right end of the throttle shaft 4 projects into the gear accommodating chamber 17 via the shaft hole 20 in the throttle body 2 and the shaft hole 21 in the left case member 13. As illustrated in FIGS. 7 and 8, a boss portion 2a with an annular shape around the throttle shaft 4 is provided to project on the right side of the throttle body 2, and an annular projecting portion 13a provided to project on the left side of the left case member 13 is externally fitted onto the boss portion 2a via an O ring 30. A slight gap is formed in a direction perpendicularly intersecting an axis C of the throttle shaft 4, that is, a radial direction between the boss portion 2a and the annular projecting portion 13a to thereby allow relative displacement.

A stepped surface 32 that has a diameter reduced in a stepwise manner, faces the right side, and has an annular shape is formed at the right end portion of the throttle shaft 4, an O ring groove 33 is formed on the right side of the stepped surface 32, and an O ring 34 is fitted thereinto. The bearing 6 includes an inner ring 6a, an outer ring 6b, a ball 6c, and a holder, which is not illustrated. The inner ring 6a is fitted to the throttle shaft 4 from the right side and abuts the stepped surface 32, and a part between an inner circumferential surface of the inner ring 6a and an outer circumferential surface of the throttle shaft 4 is held in an air tight manner by the O ring 34.

A collar 35 with a cylindrical shape is fitted to the throttle shaft 4 from the right side. A male screw 36 and a pair of planes 37 facing at 180° are formed at a right part of the collar 35 in the throttle shaft 4. A chamfered hole 22b formed in a core metal 22a of the driven gear 22 is fitted to this part from the right side, and rotation of the driven gear 22 with respect to the throttle shaft 4 is stopped along with the core metal 22a through engagement between the chamfered hole 22b and each plane 37. A fixing nut 39 is screwed onto the male screw 36 via a washer 38, and the inner ring 6a of the bearing 6 is sandwiched with the stepped surface 32 via the washer 38, the core metal 22a, and the collar 35 in response to a fastening force of the fixing nut 39. In this manner, the driven gear 22 is fixed to the right end of the throttle shaft 4, and the inner ring 6a is positioned in a direction along the axis C of the throttle shaft 4, that is, a thrust direction.

A body-side annular fitting portion 41 with an annular shape around the throttle shaft 4 is formed to be adjacent to the shaft hole 20 in the throttle body 2 on its right side. Also, a case-side annular fitting portion 42 with an annular around the throttle shaft 4 is formed to be adjacent to the shaft hole 21 of the left case member 13 on its left side. A movement restricting surface 43 with an annular shape facing the left side is formed between the shaft hole 21 and the case-side annular fitting portion 42. An inner circumferential surface of the shaft hole 21 is spaced apart from the outer circumferential surface of the throttle shaft 4 to form a gap 44, and the aforementioned collar 35 abuts the inner ring 6a of the bearing 6 as being arranged in the gap 44. The body-side annular fitting portion 41 and the case-side annular fitting portion 42 are set to have the same inner diameter and continue in the left-right direction in a mutually adjacent positional relationship.

The outer ring 6b of the bearing 6 is press-fitted into the case-side annular fitting portion 42 and abuts the movement restricting surface 43 from the left side. A positioning ring 45 with a cylindrical shape is disposed on the left side of the outer ring 6b, about half the positioning ring 45 on the left side is fitted into the body-side annular fitting portion 41, and about half on the right side is fitted into the case-side annular fitting portion 42. Also, the thickness of the positioning ring 45 in the radial direction is slightly thicker than the thickness of the outer ring 6b of the bearing 6, and a right end surface of the positioning ring 45 abuts a left end surface of the outer ring 6b. Although the body-side annular fitting portion 41 and the case-side annular fitting portion 42 have the same inner diameter as described above, a tolerance corresponding to a so-called clearance fit is set for the body-side annular fitting portion 41, and a tolerance corresponding to a so-called interference fit is set for the case-side annular fitting portion 42, with respect to the outer diameter of the positioning ring 45. Therefore, the positioning ring 45 is inserted into the body-side annular fitting portion 41 with substantially no clearance formed therebetween, while the positioning ring 45 is press-fitted into the case-side annular fitting portion 42 and a large force is needed to insert and pull out the positioning ring 45.

The positioning ring 45 is produced by a cutting work using free-cutting brass steal or the like as a material. However, the present invention is not limited thereto, and the material and the manufacturing method can be optionally changed. With such a positioning ring 45, the outer ring 6b of the bearing 6 is sandwiched between the positioning ring 45 and the movement restricting surface 43 and is thereby positioned in the direction along the axis C of the throttle shaft 4, that is, the thrust direction.

Also, the right side of the positioning ring 45 is press-fitted into the case-side annular fitting portion 42, and the left side is inserted into the body-side annular fitting portion 41. Since the gap is formed and displacement is allowed between the boss portion 2a and the annular projecting portion 13a as described above, the throttle body 2 and the left case member 13 are positioned in the direction perpendicularly intersecting the axis C, that is, the radial direction via the positioning ring 45.

Then, effects of the throttle device 1 described above, particularly, effects achieved by the support structure at the right end portion of the throttle shaft 4 will be described.

First, the inner ring 6a of the bearing 6 is sandwiched between the stepped surface 32 of the throttle shaft 4 and the fixing nut 39 to be positioned in the direction of the axis C of the throttle shaft 4. Therefore, once the throttle shaft 4 is about to be displaced along the axis C in response to some external force, the inner ring 6a of the bearing 6 starts to be displaced in the same direction integrally with the throttle shaft 4, and the force acts on the outer ring 6b via the ball 6c.

On the other hand, the outer ring 6b of the bearing 6 is sandwiched between the movement restricting surface 43 of the left case member 13 and the positioning ring 45 to be positioned in the direction of the axis C. Specifically, the outer ring 6b is adapted such that displacement is restricted not only by friction against the inner circumferential surface of the case-side annular fitting portion 42, but displacement to the right side is also restricted by the movement restricting surface 43, and displacement to the left side is also restricted by the positioning ring 45. Since the outer ring 6b is fixedly positioned in the direction of the axis C in this manner, the outer ring 6b is maintained at a prescribed position without being displaced even in a case where the displacement of the throttle shaft 4 in the direction of the axis C is transmitted via the inner ring 6a and the ball 6c. In other words, the displacement of the throttle shaft 4 in the direction of the axis C is restricted via the ball 6c and the inner ring 6a by the outer ring 6b being maintained at the prescribed position. If the throttle valve 7 is displaced in the direction of the axis C, a trouble in which both side portions of the throttle valve 7 come into slide contact with the inner circumferential surface of the throttle bore 3 and cannot be smoothly opened and closed or the like may occur. Since such a trouble can be prevented in advance, it is possible to improve reliability of the throttle device 1.

In particular, the positioning ring 45 in the embodiment has a longer length of contact with each of the annular fitting portions 41 and 42 in the left-right direction than that of the outer ring 6b, the positioning ring 45 thus comes into contact with the inner circumferential surfaces of the annular fitting portions 41 and 42 in wider areas, and displacement is further fixedly restricted by friction therebetween. Inevitably, displacement of the outer ring 6b to the left side is also reliably restricted by the positioning ring 45 similarly to the restriction of displacement of the outer ring 6b to the right side achieved by the movement restricting surface 43. Therefore, it is possible to more fixedly position the outer ring 6b and to thereby further reliably restrict displacement of the throttle valve 7 in the direction of the axis C.

In this manner, the throttle device 1 in the embodiment realizes the positioning of the throttle shaft 4 in the direction of the axis C without providing the compression spring on the throttle shaft 4 unlike the technology in Patent Literature 1. It is thus possible to reduce the external dimension of the throttle device 1, particularly, the external dimension of the throttle shaft 4 in the direction of the axis C and to thereby improve mountability on the engine.

On the other hand, the throttle body 2 and the left case member 13 are provided as separated members in the embodiment. This is for achieving size reduction of a mold and simplification of the mold shape by individually injection-molding both the members 2 and 13. However, in this case, it is necessary to secure coaxial precision when the throttle body 2 is coupled to the left case member 13. The coaxial precision means precision related to a positional relationship between the throttle body 2 and the left case member 13 in the direction perpendicularly intersecting the axis C of the throttle shaft 4.

For example, the driven gear 22 is supported on the side of the throttle body 2 via the throttle shaft 4, and the intermediate gear 29 engaged with this is supported on the side of the left case member 13 via the gear shaft 27. Therefore, in a case where the coaxial precision between the throttle body 2 and the left case member 13 is degraded, an engagement state between the driven gear 22 and the small diameter portion 29b of the intermediate gear 29 may deteriorate, and defects such as noise generation and abrasion promotion may occur. There is also a likelihood that the function of the waterproof packing 15 is damaged due to degradation of the coaxial precision, and in that case, rainwater or the like may enter the gear accommodating chamber 17.

The positioning ring 45 in the embodiment is adapted such that not only the right side thereof is press-fitted into the case-side annular fitting portion 42 and positions the outer ring 6b of the bearing 6 but the left side thereof is inserted into the body-side annular fitting portion 41. As a result, the throttle body 2 and the left case member 13 are maintained in the normal positional relationship in the direction perpendicularly intersecting the axis C via the positioning ring 45, and it is thus possible to achieve high coaxial precision and to prevent defects as described above in advance.

In addition, the positioning ring 45 exhibits two functions, namely positioning of outer ring 6b of the bearing 6 in the direction of the axis C and positioning of the throttle body 2 and the left case member 13 in the direction perpendicularly intersecting the axis C. Although it is also possible to achieve each of the functions by different members, a large space is needed to install each member, and the structure around the bearing becomes complicated in that case. Since both functions can be achieved by the single positioning ring 45 at the same time, this point contributes to size reduction and manufacturing cost reduction of the throttle device 1.

Also, the fastening force of the fixing nut 39 is caused to act on the inner ring 6a of the bearing 6 via the collar 35 with the cylindrical shape in the embodiment. As illustrated in FIG. 8, the bearing 6 is disposed at a coupling part between the throttle body 2 and the left case member 13, in other words, a fitting part between the boss portion 2a and the annular projecting portion 13a. On the other hand, the fixing nut 39 is disposed inside the gear accommodating chamber 17 to fasten the driven gear 22 to the right end of the throttle shaft 4, and as a result, the bearing 6 and the fixing nut 39 are spaced apart in the left-right direction. Although adding a part corresponding to the sectional shape of the collar 35 to the core metal 22a of the driven gear 22 and causing the part to abut the inner ring 6a are also conceivable, for example, the sectional shape of the core metal 22a changes from the flat plate shape to a complicated shape, and this may lead to an increase in cost. It is possible to cause the fastening force of the fixing nut 39 to act on the inner ring 6a merely by adding the collar 35 with the simple cylindrical shape between the inner ring 6a and the driven gear 22, and this point contributes to cost reduction of the throttle device 1.

Also, the shaft hole 21 into which the throttle shaft 4 is inserted is formed in the left case member 13, the case-side annular fitting portion 42 into which the outer ring 6b of the bearing 6 and the positioning ring 45 are press-fitted is formed on the left side of the shaft hole 21, the movement restricting surface 43 restricting displacement of the outer ring 6b to the right side is formed between the shaft hole 21 and the case-side annular fitting portion 42, and further, the gap 44 for causing the collar 35 to abut the inner ring 6a of the bearing 6 is formed between the inner circumferential surface of the shaft hole 21 and the outer circumferential surface of the throttle shaft 4. The four parts exhibiting different functions in this manner are provided in an aggregated manner in the left case member 13 in the mutually adjacent positional relationship. This point contributes to size reduction of the throttle device 1.

Aspects of the present invention are not limited to the embodiment. For example, although the above embodiment is implemented as the throttle device 1 applied to a two-cylinder engine mounted in a motorcycle, the invention is not limited thereto. As examples of the vehicle in which the engine is mounted, the invention may be applied to a passenger vehicle, a bicycle with an electric motor, or a so-called all-terrain vehicle (ATV) such as a four-wheeled buggy, and the form of the engine can also be optionally changed.

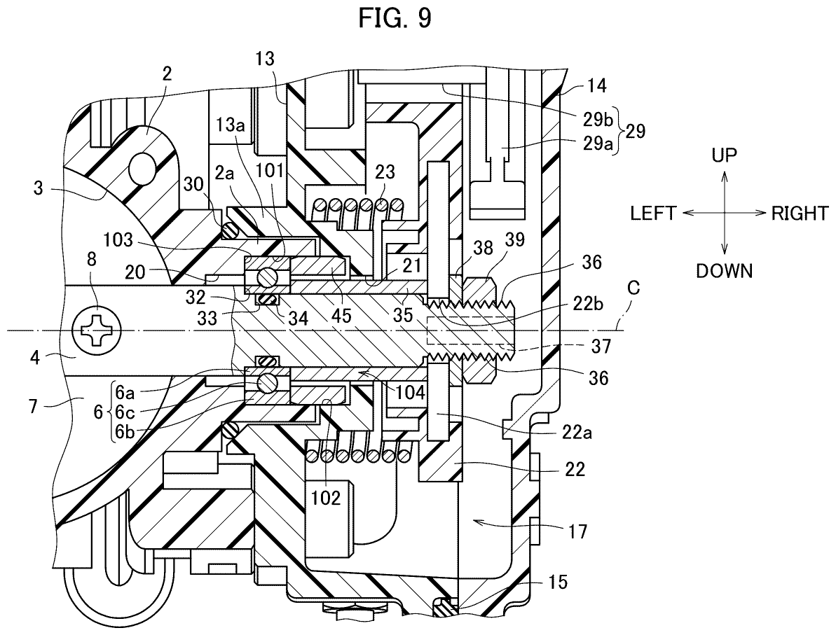

Although the positioning ring 45 is disposed on the side of the throttle body 2, and the bearing 6 is disposed on the side of the left case member 13 in the above embodiment, the present invention is not limited thereto. For example, the positional relationship between the bearing 6 and the positioning ring 45 may be reversed. FIG. 9 is a sectional view illustrating this different example and corresponding to FIG. 8, and hereinafter, parts that are different from those in the above embodiment will be mainly described.

A body-side annular fitting portion 101 is formed on the right side of the shaft hole 20 in the throttle body 2, and a movement restricting surface 103 facing the right side is formed between the bearing 6 and the body-side annular fitting portion 101. A case-side annular fitting portion 102 is formed on the left side of the shaft hole 21 in the left case member 13, and a gap 104 is formed between the inner circumferential surface of the shaft hole 21 and the outer circumferential surface of the throttle shaft 4. The inner ring 6a of the bearing 6 is fitted to the throttle shaft 4 from the right side, the collar 35 is fitted to the throttle shaft 4 via the gap 104, and the inner ring 6a of the bearing 6 is sandwiched with the stepped surface 32 via the washer 38, the core metal 22a, and the collar 35.

The outer ring 6b of the bearing 6 is press-fitted into the body-side annular fitting portion 101, about half the positioning ring 45 on the left side is press-fitted thereinto, and about half the positioning ring 45 on the right side is inserted into the case-side annular fitting portion 102. It is possible to achieve effects similar to those of the above embodiment even by the throttle device 1 in the different example configured as described above although description is not repeated.

### REFERENCE SIGNS LIST

1 throttle device
2 throttle body
3 throttle bore
4 throttle shaft
6 bearing
6a inner ring
6b outer ring
7 throttle valve
18 gear case
20, 21 shaft hole
22 driven gear (gear train)
26 driving gear (gear train)
29 intermediate gear (gear train)
32 stepped surface
35 collar
39 fixing nut
41, 101 body-side annular fitting portion
42, 102 case-side annular fitting portion
43, 103 movement restricting surface
44, 104 gap
45 positioning ring

What is claimed is:

1. An engine throttle device in which a throttle valve is supported inside a throttle bore of a throttle body by a throttle shaft such that the throttle valve is able to be opened and closed, a gear case accommodating gear trains is fixed to a side portion of the throttle body, and one end of the throttle shaft is caused to project into the gear case via a shaft hole and is driven via the gear trains, the engine throttle device comprising:
an annular fitting portion formed to be adjacent to the shaft hole;
a bearing having an outer ring fitted to the annular fitting portion and an inner ring fitted to the throttle shaft, and rotatably supporting the throttle shaft;
a positioning ring pressure-fitted into the annular fitting portion and abutting the outer ring to restrict displacement of the outer ring along an axis of the throttle shaft; and
a fixing nut screwed onto the one end of the throttle shaft inside the gear case and abutting the inner ring on one end side to restrict displacement of the inner ring to the one end side.

2. The engine throttle device according to claim 1, wherein
the shaft hole is formed in the gear case, and a case-side annular fitting portion as the annular fitting portion is formed on the other end side of the shaft hole, and
the positioning ring abuts the outer ring from the other end side inside the case-side annular fitting portion to restrict displacement of the outer ring to the other end side.

3. The engine throttle device according to claim 2, wherein
a movement restricting surface facing the other end side is formed between the shaft hole and the case-side annular fitting portion in the gear case, and
the positioning ring positions the outer ring in an axial direction of the throttle shaft with the outer ring sandwiched between the positioning ring and the movement restricting surface.

4. The engine throttle device according to claim 3, wherein
a stepped surface facing the one end side is formed in the throttle shaft, and
the fixing nut positions an inner ring of the bearing in an axial direction of the throttle shaft with the inner ring sandwiched between the fixing nut and the stepped surface.

5. The engine throttle device according to claim 4, further comprising:
a collar with a cylindrical shape fitted to the throttle shaft and abutting the inner ring on the one end side, wherein
the fixing nut sandwiches the inner ring of the bearing between the fixing nut and the stepped surface via the collar.

6. The engine throttle device according to claim 5, wherein
an inner circumferential surface of the shaft hole forms a gap between the inner circumferential surface and an outer circumferential surface of the throttle shaft, and
the collar abuts the inner ring as being arranged in the gap.

7. The engine throttle device according to claim 2, wherein
a body-side annular fitting portion that is adjacent to the other end side of the case-side annular fitting portion is formed in the throttle body, and
the positioning ring is press-fitted into the case-side annular fitting portion and is inserted into the body-side annular fitting portion.

8. The engine throttle device according to claim 7, wherein
a stepped surface facing the one end side is formed in the throttle shaft, and
the fixing nut positions an inner ring of the bearing in an axial direction of the throttle shaft with the inner ring sandwiched between the fixing nut and the stepped surface.

9. The engine throttle device according to claim 8, further comprising:
a collar with a cylindrical shape fitted to the throttle shaft and abutting the inner ring on the one end side, wherein
the fixing nut sandwiches the inner ring of the bearing between the fixing nut and the stepped surface via the collar.

10. The engine throttle device according to claim 9, wherein
an inner circumferential surface of the shaft hole forms a gap between the inner circumferential surface and an outer circumferential surface of the throttle shaft, and
the collar abuts the inner ring as being arranged in the gap.

11. The engine throttle device according to claim 2, wherein
a stepped surface facing the one end side is formed in the throttle shaft, and
the fixing nut positions an inner ring of the bearing in an axial direction of the throttle shaft with the inner ring sandwiched between the fixing nut and the stepped surface.

12. The engine throttle device according to claim 11, further comprising:
a collar with a cylindrical shape fitted to the throttle shaft and abutting the inner ring on the one end side, wherein
the fixing nut sandwiches the inner ring of the bearing between the fixing nut and the stepped surface via the collar.

13. The engine throttle device according to claim 12, wherein
an inner circumferential surface of the shaft hole forms a gap between the inner circumferential surface and an outer circumferential surface of the throttle shaft, and
the collar abuts the inner ring as being arranged in the gap.

14. The engine throttle device according to claim 1, wherein
a stepped surface facing the one end side is formed in the throttle shaft, and
the fixing nut positions an inner ring of the bearing in an axial direction of the throttle shaft with the inner ring sandwiched between the fixing nut and the stepped surface.

15. The engine throttle device according to claim 14, further comprising:
a collar with a cylindrical shape fitted to the throttle shaft and abutting the inner ring on the one end side, wherein
the fixing nut sandwiches the inner ring of the bearing between the fixing nut and the stepped surface via the collar.

16. The engine throttle device according to claim 15, wherein
an inner circumferential surface of the shaft hole forms a gap between the inner circumferential surface and an outer circumferential surface of the throttle shaft, and
the collar abuts the inner ring as being arranged in the gap.

17. The engine throttle device according to claim 1, wherein
the shaft hole is formed in the throttle body, and a body-side annular fitting portion as the annular fitting portion is formed on the one end side of the shaft hole, and
the positioning ring abuts the outer ring on the one end side inside the body-side annular fitting portion to restrict displacement of the outer ring to the one end side.
